(19) United States
(12) Patent Application Publication
(10) Pub. No.: US 2006/0215417 A1
(43) Pub. Date: Sep. 28, 2006

(54) Shining tray structure

(76) Inventor: Pi-Sun Chen, Rende Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/237,926

(22) Filed: Sep. 29, 2005

(30) Foreign Application Priority Data
Mar. 25, 2005 (TW) 094204620

(51) Int. Cl. F21L 4/02; F21V 33/00; F21V 8/00

(52) U.S. Cl. 362/555; 362/577; 362/190; 362/97

(57) ABSTRACT

A shining tray includes a main body, several light producing devices, light guiding members, and a sealing member; the main body has an raised edge, and an outer surrounding portion encompassing the raised edge and extending downwards from an upper end of the raised edge such that a holding room is formed between the raised edge and the outer surrounding portion; the light producing devices are held in the holding room; the light guiding members are held in the holding room, and abut the light producing devices; the sealing member is tightly held in the holding room so as to prevent water from leaking into the holding room and to fix the light producing devices as well as the light guiding members in position.

### BACKGROUND OF THE INVENTION

1. Field of the invention

The present invention relates to a shining tray, more particularly one, which has a relatively simple structure, and is easy to assemble and inexpensive to manufacture.

2. Brief Description of the Prior Art

Referring to FIGS. 1 and 2, a conventional shining tray includes a main body 1, an outer body 2, and a light producing device 3. The main body 1 is formed with an annular groove 11 near to the bottom thereof, an annular trench 12 near to the bottom, an annular recess 13 near to the top, and an annular trench 14 near to the top. The outer body 2 is formed with an annular groove 21 on the inner side thereof, an annular protrusion 22 on the inner side, and an annular protrusion 23 on the outward edge thereof. An inner leak-prevention ring 24 is partially held in the annular groove 11 of the main body 1 while an outer leak-prevention ring 25 is held in the annular recess 13 of the main body 1. The main body 1 and the outer body 2 are joined together with the rest of the inner leak-prevention ring 24 being fitted in the annular groove 21 of the outer body 2, the annular protrusion 22 being fitted in the annular trench 12, and the annular protrusion 23 being fitted in the annular trench 14. And, there is a holding room formed between the main body 1 and the outer body 2. The light producing device 3 includes several light emitting members 31, and it is held in the holding room between the main body 1 and the outer body 2. Therefore, when the light producing device 3 is turned on, the light emitting members 31 will emit light, which will travel outside through the outer body 2. However, the shining tray has a relatively complicated structure, and it is time-consuming to assemble and expensive to manufacture. Consequently, such structure is unsuitable for mass production.

### SUMMARY OF THE INVENTION

It is a main object of the invention to provide an improvement on a shining tray to overcome the above-mentioned problem. The shining tray of the present invention includes a main body, several light producing devices, light guiding members, and a sealing member. The main body has a raised edge, and an outer surrounding portion, which encompasses the raised edge, and extends downwards from an upper end of the raised edge such that a holding room is formed between the raised edge and the outer surrounding portion. The light producing devices are held in the holding room while the light guiding members are held in the holding room, and abut the light producing devices. The sealing member is tightly held in the holding room so as to prevent water from leaking into the holding room and to fix the light producing devices and the light guiding members in position.

### BRIEF DESCRIPTION OF THE DRAWINGS

The present invention will be better understood by referring to the accompanying drawings; wherein:

FIG. 1 is an exploded perspective view of the conventional shining tray,

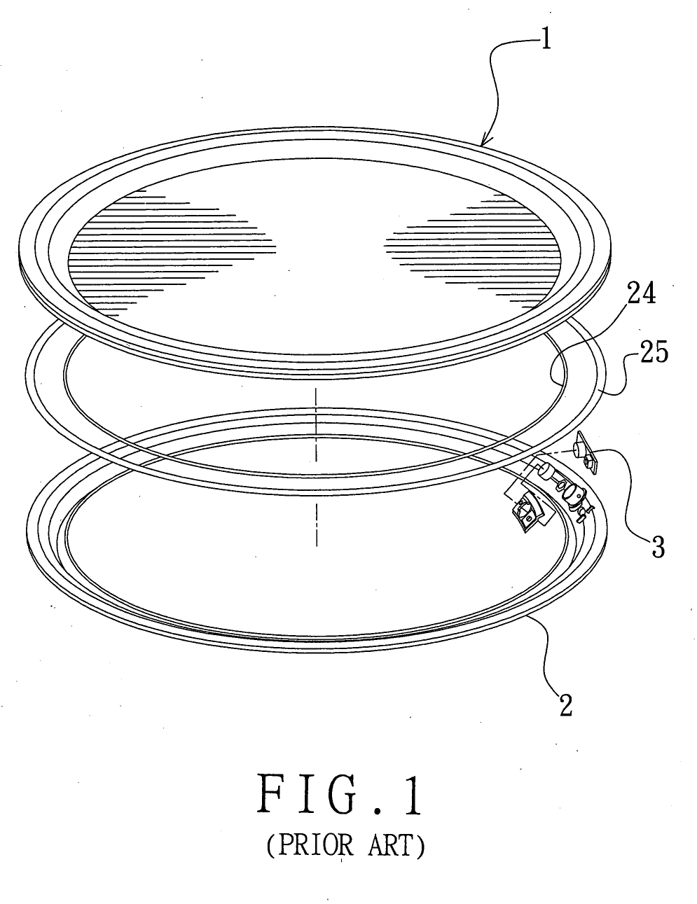

FIG. 2 is a lateral sectional view of the conventional shining tray,

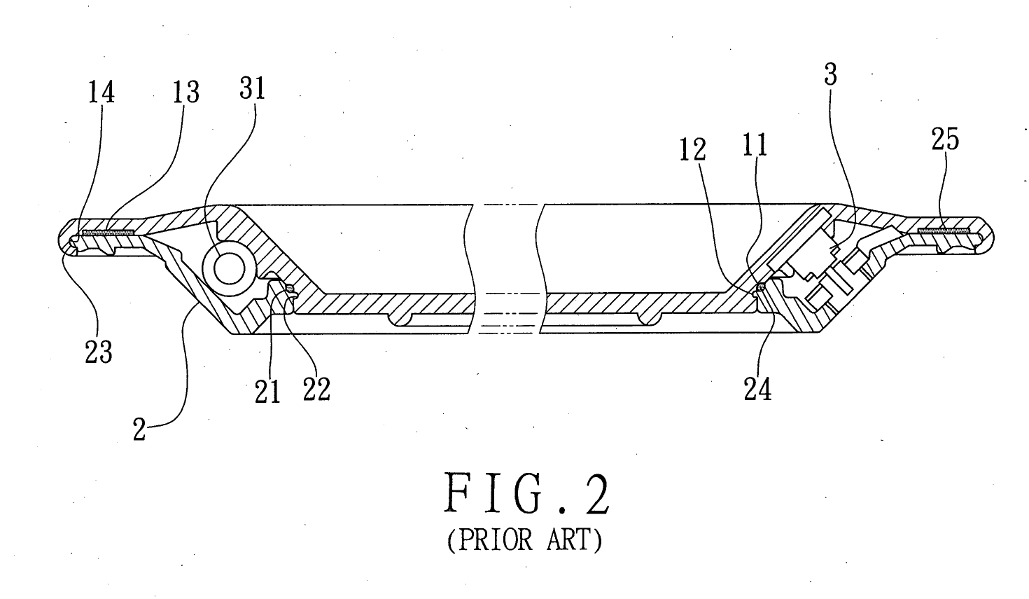

FIG. 3 is an exploded perspective view of the shining tray in the present invention,

FIG. 4 is lateral sectional view of the present shining tray, and

FIG. 5 is a view of the present shining tray in use.

### DETAILED DESCRIPTION OF THE PREFERRED EMBODIMENTS

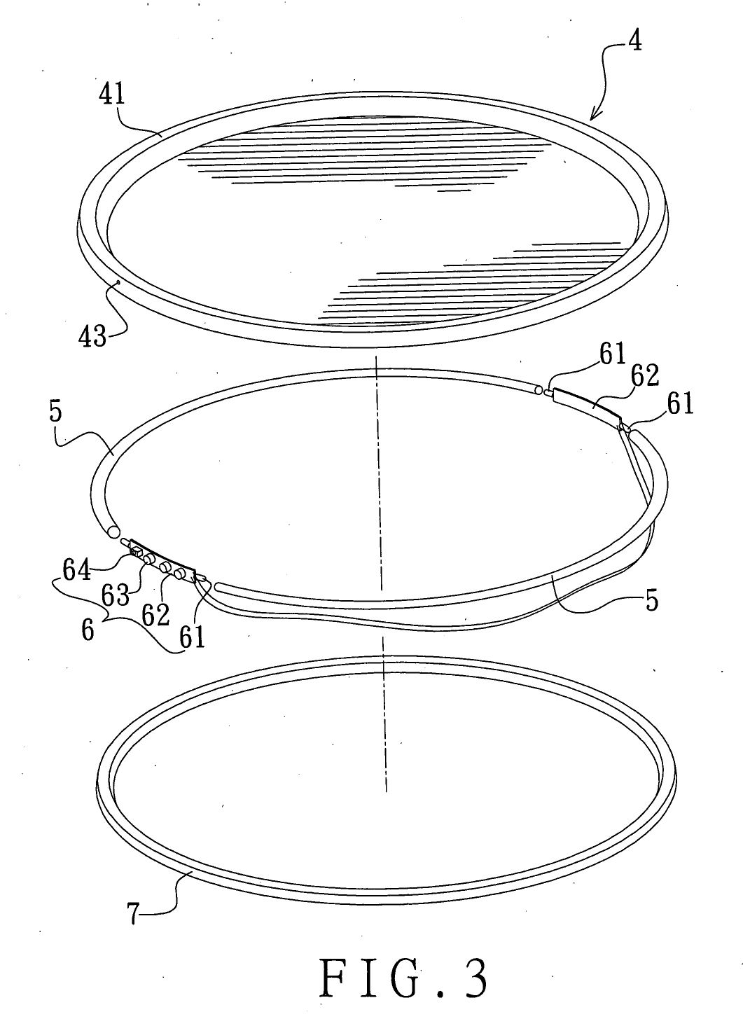

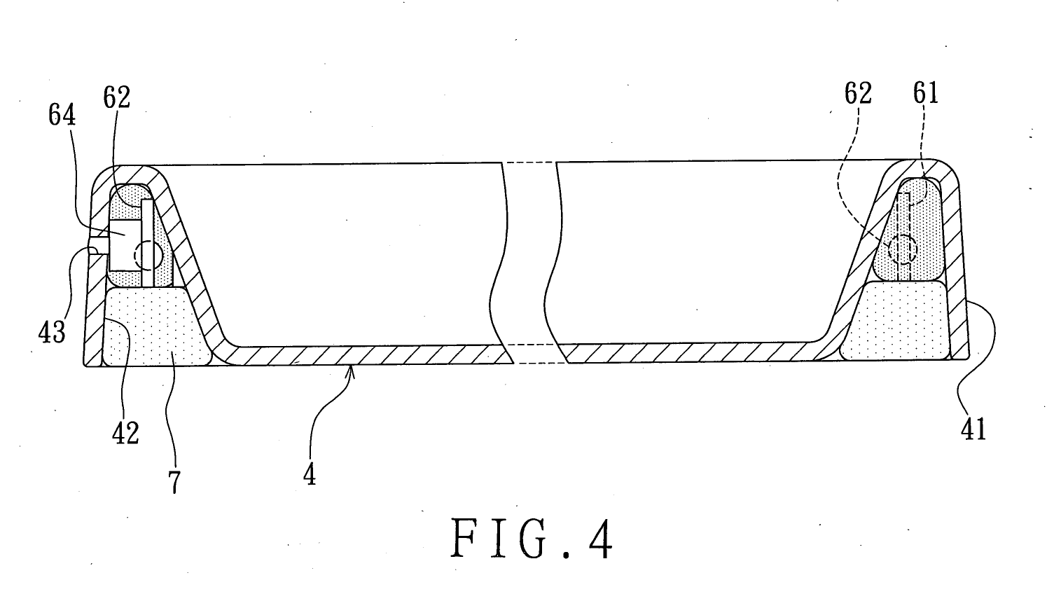

Referring to FIGS. 3 and 4, a preferred embodiment of a shining tray of the present invention includes a transparent main body 4, several light producing devices 6, several light guiding members 5, and a sealing member 7.

The main body 4 has a raised edge, and an outer surrounding portion 41 encompassing the raised edge. The outer surrounding portion 41 extends downwards from an upper end of the raised edge such that there is a holding room 42, which becomes gradually wider towards the lower end, between the raised edge and the outer surrounding portion 41. Furthermore, the main body 4 has a through hole 43 communicating with the holding room 42.

The light producing devices 6 are held in the holding room 42 of the main body 4, and electrically connected. Each of the light producing devices 6 includes a circuit board 62, and two light emitting members 61. One of the light producing devices 6 further has a battery set 63 connected to the circuit board 62, and a push-button switch 64, which is positioned next to the battery set 63 and connected to the circuit board 62, and projects outwards through the through hole 43 of the main body 4. Each of the light emitting members 61 is connected to a respective one of two ends of the circuit board 62, and the control circuit of the circuit board 62 will make the light emitting members 61 flash on and off repeatedly. Therefore, light from the light emitting members 61 will travel outside through the transparent main body 4.

The light guiding members 5 are elongate and thin, and they are positioned inside the holding room 42 of the main body 1, and abut and touch two adjacent ones of the light emitting members 61 at two ends thereof; thus, light from the light emitting members 61 will travel the whole length of the holding room 42 of the main body 1 owing to guidance of the light guiding members 5.

The sealing member 7 gradually becomes wider towards a lower end thereof, and it is tightly held in the lower portion of the holding room 42 of the main body 4 to seal the holding room 42; thus, the light producing devices 6 and the light guiding members 5 are fixed in position by means of the sealing member 7, and water can't leak into the holding room 42 to cause damage to the light producing devices 6.

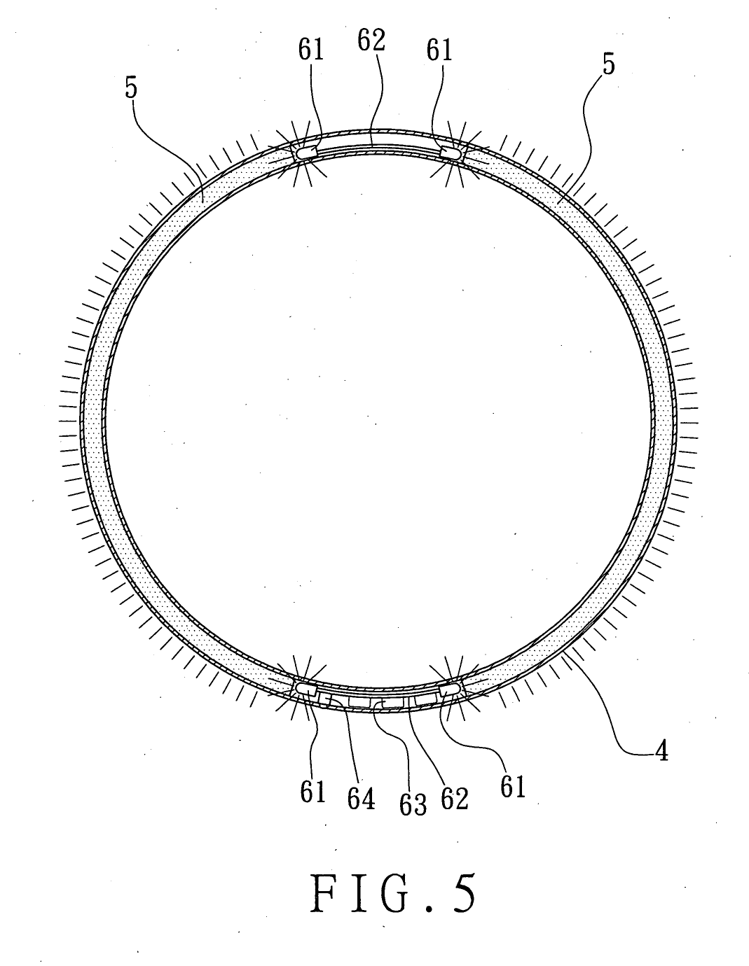

Referring to FIGS. 4 and 5, when the push-button switch 64 is pressed so as to turn on the light producing devices 6, the light emitting members 61 will emit light, which will travel the whole distance of the holding room 42 of the main body 4, and travel outside through the whole raised edge and the whole outer surrounding portion 41 of the main body 4.

When comparing the shining tray of the present invention with the conventional one, it can be easily seen that the present invention has a much simpler structure, and it is much easier to assemble and cheaper to manufacture.

What is claimed is:

1. An improvement on shining tray structure, comprising
a main body; the main body having an outer surrounding portion, which encompasses an raised edge of the main body, and extends downwards from an upper end of the raised edge such that a holding room is formed between the raised edge and the outer surrounding portion;
a plurality of light producing devices held in the holding room of the main body;
a plurality of light guiding members held in the holding room of the main body and abutting the light producing devices; and
a sealing member tightly held in the holding room of the main body so as to prevent water from leaking into the holding room and fix the light producing devices and the light guiding members in position.

2. The improvement on shining tray structure as claimed in claim 1, wherein each of the light producing devices includes a circuit board, and light emitting members on two ends of the circuit board, and the light guiding members abut and touch two adjacent ones of the light emitting members at two ends thereof; at least one of the light producing devices having a battery set connected to the circuit board thereof, and a push-button switch for controlling electricity to the light emitting members, which push-button switch is positioned next to the battery set and connected to the circuit board, and projects outwards through a through hole of the main body.

3. The improvement on shining tray structure as claimed in claim 2, wherein the circuit board has a control circuit for making the light emitting members flash on and off repeatedly.
